(19) United States
(12) Patent Application Publication
(10) Pub. No.: US 2025/0327678 A1
(43) Pub. Date: Oct. 23, 2025

(54) MOBILITY CONTROL APPARATUS AND METHOD THEREOF

(71) Applicants: HYUNDAI MOTOR COMPANY, Seoul (KR); Kia Corporation, Seoul (KR)

(72) Inventors: Tae Ho LEE, Hwaseong-si (KR); Jae Joong KIM, Hwaseong-si (KR)

(21) Appl. No.: 18/962,247

(22) Filed: Nov. 27, 2024

(30) Foreign Application Priority Data
Apr. 22, 2024 (KR) 10-2024-0053522

(51) Int. Cl. G01C 21/36; G01C 21/34

(52) U.S. Cl. CPC G01C 21/3605; G01C 21/343; G01C 21/3484

(57) ABSTRACT

A mobility control apparatus and a method thereof are provided. The mobility control apparatus includes a memory storing pieces of account information respectively corresponding to a plurality of user accounts and a processor. The processor identifies a function, execution of which is required in a driving environment of a mobility, based on the driving environment, and executes the function by using first account information corresponding to a first user account in which the function is executable among the plurality of user accounts among the pieces of account information, based on identifying the first user account. The driving environment includes at least one of a section associated with driving of the mobility, an area associated with the driving of the mobility, or a time associated with the driving of the mobility, or any combination thereof.

### CROSS-REFERENCE TO RELATED APPLICATION

This application claims the benefit of priority to Korean Patent Application No. 10-2024-0053522, filed in the Korean Intellectual Property Office on Apr. 22, 2024, the entire contents of which are incorporated herein by reference.

### TECHNICAL FIELD

The present disclosure relates to a mobility control apparatus and a method thereof, and more particularly, relates to technologies for changing functions executed by the mobility control apparatus.

### BACKGROUND

A method for managing various user accounts to perform specific functions while a vehicle is in motion have been explored.

In particular, master permission need to be granted to a designated account for executing a certain function. Since it is inefficient for a user to manually change the master permission or log in to a specific user account to perform these functions, different approaches for automatically switching user accounts at specific times have been investigated.

### SUMMARY

The present disclosure is directed to a mobility control apparatus for changing a master account depending on a driving environment of a mobility, if there are several accounts in a single mobility control apparatus, and a method thereof.

The present disclosure is also directed to a mobility control apparatus for automatically changing a master account depending on the selection of a user and a method thereof.

The present disclosure is also directed to a mobility control apparatus for operating a master account depending to a driving environment of a mobility to reinforce personalization, reinforce the usability of a feature on demand (FOD) service, and reinforce a brand through efficient account operation and a method thereof.

According to an aspect of the present disclosure, a mobility control apparatus can include a memory storing pieces of account information respectively corresponding to a plurality of user accounts and a processor. The processor can identify a function, execution of which is required in a driving environment of a mobility, based on the driving environment, and can execute the function by using first account information corresponding to a first user account in which the function is executable among the plurality of user accounts among the pieces of account information, based on identifying the first user account. The driving environment can include at least one of a section associated with driving of the mobility, an area associated with the driving of the mobility, or a time associated with the driving of the mobility, or any combination thereof.

In some implementations, the processor can segment a driving section of the mobility into sub-sections, based on identifying the driving section, before the driving of the mobility is initiated, and can execute each of functions, each being required in each of the sub-sections, in each of the sub-sections by using each of pieces of account information in which each of the functions is executable, if the mobility enters each of the sub-sections, based on identifying each of the functions.

In some implementations, the processor can identify the driving section to be driven from a starting point at which the driving of the mobility will be initiated to a destination at which the mobility drives to arrive, based on identifying the destination.

In some implementations, the processor can identify second account information corresponding to a user input for requesting account switching, based on the user input, while the mobility is driving, and can switch to a second user account corresponding to the user input, based on identifying the second account information.

In some implementations, the function can include at least one of a driving assistance function of the mobility, an autonomous driving function of the mobility, a function for providing a user of the mobility with media content, a function associated with charging of the mobility, or a function for receiving traffic information for indicating a position of the mobility, or any combination thereof.

In some implementations, the processor can identify the function, the execution of which is required in the driving environment, based on determining a requirement necessary according to the driving environment.

In some implementations, the processor can identify the necessary requirement, using at least one of at least one sensor included in the mobility, first map information stored in the mobility, or second map information received from a device different from the mobility, or any combination thereof.

In some implementations, the processor can assign master account permission to the first user account corresponding to the first account information.

In some implementations, the processor can execute the function, using the first user account to which the master account permission is assigned.

In some implementations, the processor can execute the function, based on logging in to an application for executing the function using the first account information.

According to another aspect of the present disclosure, a mobility control method can include identifying, by a processor, a function, execution of which is required in a driving environment of a mobility, based on the driving environment, and executing, by the processor, the function by using first account information corresponding to a first user account in which the function is executable among a plurality of user accounts among pieces of account information, based on identifying the first user account. The driving environment can include at least one of a section associated with driving of the mobility, an area associated with the driving of the mobility, or a time associated with the driving of the mobility, or any combination thereof.

The mobility control method can further include segmenting a driving section of the mobility into sub-sections, based on identifying the driving section, before the driving of the mobility is initiated, and executing each of functions, each being required in each of the sub-sections, in each of the sub-sections by using each of the pieces of account information in which each of the functions is executable, if the mobility enters each of the sub-sections, based on identifying each of the functions.

The mobility control method can further include identifying the driving section to be driven from a starting point at which the driving of the mobility will be initiated to a destination at which the mobility drives to arrive, based on identifying the destination.

The mobility control method can further include identifying second account information corresponding to a user input for requesting account switching, based on the user input, while the mobility is driving, and switching to a second user account corresponding to the user input, based on identifying the second account information.

In some implementations, the function can include at least one of a driving assistance function of the mobility, an autonomous driving function of the mobility, a function for providing a user of the mobility with media content, a function associated with charging of the mobility, or a function for receiving traffic information for indicating a position of the mobility, or any combination thereof.

The mobility control method can further include identifying the function, the execution of which is required in the driving environment, based on determining a requirement necessary according to the driving environment.

The mobility control method can further include identifying the necessary requirement, using at least one of at least one sensor included in the mobility, first map information stored in the mobility, or second map information received from a device different from the mobility, or any combination thereof.

The mobility control method can further include assigning master account permission to the first user account corresponding to the first account information.

The mobility control method can further include executing the function, using the first user account to which the master account permission is assigned.

The mobility control method can further include executing the function, based on logging in to an application for executing the function using the first account information.

### BRIEF DESCRIPTION OF THE DRAWINGS

FIG. 1 is a diagram illustrating an example of a mobility control apparatus.

FIG. 2A is a diagram illustrating an example of changing account information.

FIG. 2B is a diagram illustrating an example of different functions executable in an account.

FIG. 2C is a diagram illustrating an example of executing a different function depending on a section.

FIG. 3 is a diagram illustrating a flowchart for describing an example of a mobility control method.

FIG. 4 is a diagram illustrating an example of a computing system associated with a mobility control apparatus or a mobility control method.

### DETAILED DESCRIPTION

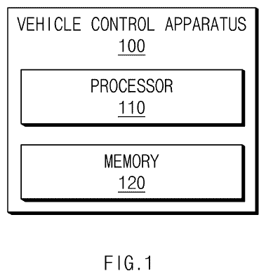

Hereinafter, the present disclosure will be described in detail with reference to FIGS. 1 to 4.

FIG. 1 is a diagram illustrating an example of a mobility control apparatus.

Referring to FIG. 1, a mobility control apparatus 100 can be implemented inside or outside a mobility, and some of the components included in the mobility control apparatus 100 can be implemented inside or outside the mobility. In some implementations, the mobility control apparatus 100 can be integrally configured with control units in the mobility or can be implemented as a separate device to be connected with the control units of the mobility by a separate connection means. For example, the mobility control apparatus 100 can further include components which are not shown in FIG. 1.

In some implementations, the mobility can include various forms of transportation. For example, the mobility can include, but is not limited to, a vehicle, a motorcycle, a bicycle, an electric bicycle, an electric kickboard, a drone, a train, a maglev train, a subway, a tram, or an urban air mobility (UAM), either individually or in combination. However, the present disclosure is not limited to these examples.

The mobility control apparatus 100 can include a processor 110 and a memory 120. The processor 110 and the memory 130 can be electronically or operably coupled to each other by an electronical component including a communication bus.

Hereinafter, the operable coupling of hardware pieces can include establishing a direct or indirect connection between them, either wired or wireless, allowing the first hardware to control the second hardware.

While different blocks are illustrated, the implementation is not limited these configurations. For example, some hardware components shown in FIG. 1 can be integrated into a single system on a chip (SoC). The types and number of hardware components in the mobility control apparatus 100 are not limited to those depicted in FIG. 1. For example, the mobility control apparatus 100 can include only some of the hardware components shown in FIG. 1.

The mobility control apparatus 100 can include hardware for processing data, based on one or more instructions. The hardware for processing the data can include the processor 110.

For example, the hardware for processing the data can include an arithmetic and logic unit (ALU), a floating point unit (FPU), a field programmable gate array (FPGA), a central processing unit (CPU), and/or an application processor (AP). In some implementations, the processor 110 can have a structure of a single-core processor or can have a structure of a multi-core processor including a dual core, a quad core, a hexa core, or an octa core.

The memory 120 of the mobility control apparatus 100 can include a hardware component for storing data and/or an instruction input and/or output from the processor 110 of the mobility control apparatus 100.

For example, the memory 120 can include a volatile memory including a random-access memory (RAM) and/or a non-volatile memory including a read-only memory (ROM).

For example, the volatile memory can include at least one of a dynamic RAM (DRAM), a static RAM (SRAM), a cache RAM, or a pseudo SRAM (PSRAM), or any combination thereof.

For example, the non-volatile memory can include at least one of a programmable ROM (PROM), an erasable PROM (EPROM), an electrically erasable PROM (EEPROM), a flash memory, a hard disk, a compact disc, a solid state drive (SSD), or an embedded multi-media card (eMMC), or any combination thereof.

The memory 120 can store one or more instructions indicating calculation and/or an operation to be performed for data by the processor 110 of the mobility control apparatus 100.

For example, a set of the one or more instructions can be referred to as a program, firmware, an operating system, a process, a routine, a sub-routine, and/or an application. Hereinafter, the installation of the application in an electronic device (e.g., the mobility control apparatus 100) can indicate that one or more instructions provided as an application are stored in the memory 120, which can imply that the one or more applications are stored in a format executable by a processor of the electronic device (e.g., a file with an extension specified by an operating system of the mobility control apparatus 100).

For example, pieces of account information respectively corresponding to a plurality of user accounts can be stored in the memory 120 of the mobility control apparatus 100. For example, the plurality of user accounts can have permission to perform a specified function.

The processor 110 of the mobility control apparatus can identify a function, execution of which is required in a driving environment of the mobility, based on the driving environment. For example, while the mobility including the mobility control apparatus 100 is in motion, the processor 110 can identify the function, the execution of which is required in the driving environment of the mobility, based on the driving environment being identified.

For example, the processor 110 can identify the driving environment of the mobility, using a sensor included in the mobility. In some implementations, the processor 110 can receive the driving environment of the mobility, via a communication circuit included in the mobility.

For example, the driving environment can include at least one of a section, an area, or a time, which is associated with driving of the mobility, or any combination thereof.

For example, the function can include at least one of a driving assistance function of the mobility, an autonomous driving function of the mobility, a function for providing a user of the mobility with media content, a function associated with charging of the mobility, or a function for receiving traffic information for indicating a position of the mobility, or any combination thereof. In some implementations, the traffic information for indicating the position of the mobility can include at least one of precise traffic information for indicating the position of the mobility, a high-definition (HD) map, or a general map, or any combination thereof.

The processor 110 can identify the function that needs to be executed in the driving environment, based on a requirement of the driving environment. For example, the processor 110 can determine the requirement according to the driving environment. In some implementations, the processor can identify the function that needs to be executed in the driving environment, based on the requirement according to the driving environment.

For example, the processor 110 can identify the requirement, using at least one of at least one sensor included in the mobility, first map information stored in the mobility, or second map information received from a device different from the mobility.

In some implementations, the processor 110 can execute, based on a first user account being identified, the function by using first account information corresponding to the first user account in which the function is executable among a plurality of user accounts among pieces of account information.

For example, the processor 110 can identify a driving section of the mobility, before the driving of the mobility is initiated. For example, the processor 110 can segment, based on the driving section being identified, the driving section of the mobility into sub-sections, before the driving of the mobility is initiated.

The processor 110 can execute each of functions, which is required in each of the sub-sections, in each of the sub-section by using each of the pieces of account information in which each of the functions is executable, if the mobility enters each of the sub-sections, based on each of the functions being identified.

For example, the processor 110 can identify a driving section to be driven from a starting point at which the driving of the mobility will be initiated to a destination at which the mobility will drive to arrive, based on the destination being identified. For example, the destination can be selected by the user.

The processor 110 can detect a user input requesting account switching from the user of the mobility. For example, while the mobility is in motion, the processor 110 can detect the user input requesting the account switching. While the mobility is in motion, the processor 110 can identify second account information corresponding to the user input requesting the account switching, based on the user input. The processor can switch to a second user account corresponding to the user input, based on the second account information being identified.

In some implementations, the processor 110 can assign master account permission to the first user account corresponding to the first account information.

In some implementations, the processor 110 can execute the function, using the first user account to which the master account permission is assigned.

In some implementations, the processor 110 can execute the function, based on logging in to an application for executing the function using the first account information.

In some implementations, the processor 110 can change master permission from the first user account to the second user account, based on the second user account corresponding to the user input being identified. For example, the processor can execute the function by using the second account information corresponding to the second user account, based on the assignment of the master permission being changed from the first user account to the second user account.

As described above, the mobility control apparatus 100 can use a different user account to execute a different function depending on the driving environment of the mobility. The mobility control apparatus 100 can reinforce a user experience by using the different user account to execute the different function depending on the driving environment of the mobility.

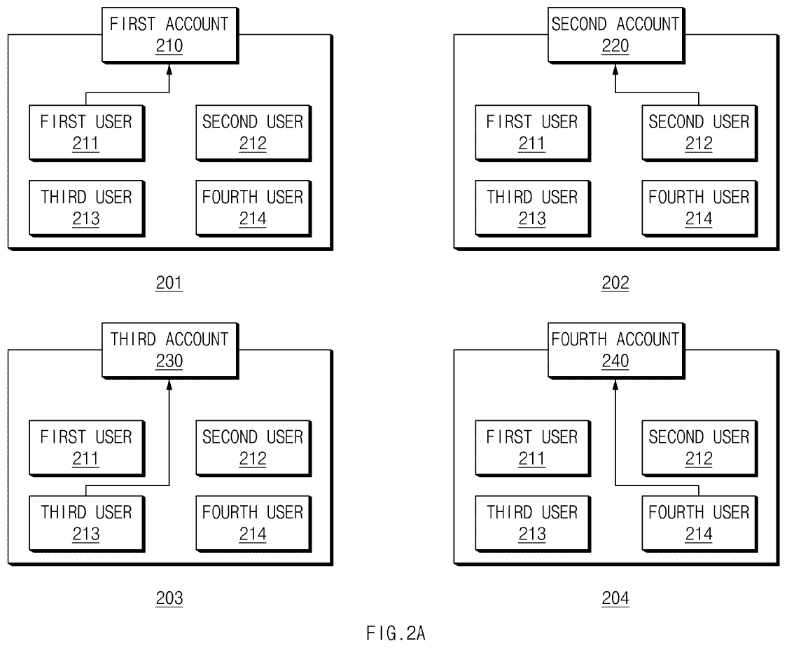

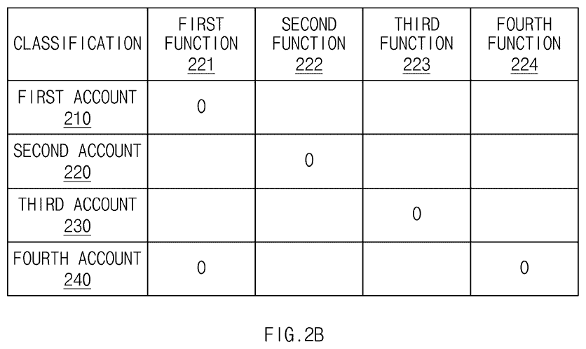

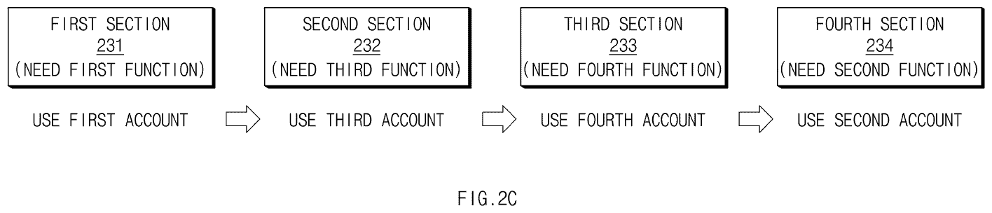

FIG. 2A is a diagram illustrating an example of changing account information.

Referring to FIG. 2A, a mobility control apparatus (e.g., a mobility control apparatus 100 of FIG. 1) can be included in a mobility capable of accommodating a plurality of users 211, 212, 213, and 214.

Referring to a first example 201, a processor (e.g., a processor 110 of FIG. 1) of the mobility control apparatus can identify a first account 210 corresponding to the first user 211.

Referring to a second example 202, the processor can identify a second account 220 corresponding to the second user 212.

Referring to a third example 203, the processor can identify a third account 230 corresponding to the third user 213.

Referring to a fourth example 204, the processor can identify a fourth account 240 corresponding to the fourth user 214.

FIG. 2A depicts the mobility accommodating the plurality of users 211, 212, 213, and 214. However, it is not necessarily required that the mobility accommodates all these users 211, 212, 213, and 214.

For example, although the mobility do not accommodate at least some of the plurality of users 211, 212, 213, and 214, if pieces of account information of the users who do not ride in the mobility are stored in a memory (e.g., a memory 120 of FIG. 1), the processor (or the mobility control apparatus) can use the pieces of stored account information.

In some implementations, the processor can determine a function executable by each of the accounts. Details associated with the function executable by each of the accounts will be described below with reference to FIG. 2B.

FIG. 2B is a diagram illustrating an example of different functions executable by an account.

Referring to FIG. 2B, first to fourth accounts 210 to can refer to first to fourth accounts 210 to 240 of FIG. 2A.

A processor (e.g., a processor 110 of FIG. 1) of a mobility control apparatus (e.g., a mobility control apparatus of FIG. 1) can identify executable functions, using each of the first to fourth accounts 210 to 240.

In some implementations, the processor can identify that it is possible to execute the first function 221 using the first account 210.

In some implementations, the processor can identify that it is possible to execute the second function 222 using the second account 220.

In some implementations, the processor can identify that it is possible to execute the third function 223 using the third account 230.

In some implementations, the processor can identify that it is possible to execute the first function 221 and the fourth function 224 using the fourth account 240.

In FIG. 2B, it is described that the first function is executable by the first account 210, that the second function 222 is executable by the second account 220, that the third function 223 is executable by the third account 230, and that the first function 221 and the fourth function 224 are executable by the fourth account 240, but an implementation is not limited thereto.

For example, there may be an account in which two functions are executable, such as the fourth account 240 of FIG. 2B, but there may be an account, which is a single account, in which three or more functions are executable.

FIG. 2C is a diagram illustrating an example of executing a different function depending on a section.

Referring to FIG. 2C, a processor (e.g., a processor of FIG. 1) of a mobility control apparatus (e.g., a mobility control apparatus 100 of FIG. 1) can identify a driving environment of a mobility. For example, the driving environment can include at least one of a section, an area, or a time, which is associated with driving of the mobility.

An example associated with the driving of the mobility in the driving environment of the mobility in FIG. 2C will be described below.

In some implementations, the processor can identify each of functions, execution of which is required in each of a plurality of sections in the mobility. FIG. 2C only illustrates an example of segmenting the plurality of sections into a first section 231, a second section 232, a third section 233, and a fourth section 234, but an implementation of the present disclosure is not limited thereto.

In some implementations, the processor can identify that the execution of the first function is required, in the first section 231. For example, the first function can be associated with at least one of an autonomous driving mode of the mobility or a driving assistance mode of the mobility.

The processor can search for a user account in which a first function is executable, based on identifying that the execution of the first function is required, in the first section 231. Referring to FIG. 2B, the processor can search for a first account and/or a fourth account in which the first function is executable.

The processor can identify an account which is relatively easy to be accessed between the first account and the fourth account in which the first function is executable. For example, the account which is relatively easy to be accessed can include an account which is currently logged in. If the first account is currently logged in, the processor can execute the first function using the first account, in the first section 231.

In some implementations, the processor can identify that the execution of the third function is required, in the second section 232. For example, the third function can be associated with execution of an application for providing a user with media content.

The processor can search for a user account in which a third function is executable, based on that identifying that the execution of the third function is required, in the second section 232. Referring to FIG. 2B, the processor can search for a third account in which the third function is executable.

In some implementations, the processor can change the logged-in account from the first account to the third account, if the mobility enters the second section 232, based on the third account in which the third function is executable being found through the search. If the mobility enters the second section 232, the processor can change master permission from the first account to the third account. For example, if the mobility enters the second section 232, the processor can assign master permission to the third account, thus executing the third function, in the second section 232.

In some implementations, the processor can identify that the execution of the fourth function is required, in the third section 233. For example, the fourth function can include a function associated with charging of a battery included in the mobility. In some implementations, the function associated with the charging of the battery included in the mobility can include a function in which an electric charging station is usable for free.

The processor can search for a user account in which a fourth function is executable, based on that identifying that the execution of the fourth function is required, in the third section 233. Referring to FIG. 2B, the processor can search for a fourth account in which the fourth function is executable.

In some implementations, the processor can change the logged-in account from the third account to the fourth account, if the mobility enters the third section 233, based on the fourth account in which the fourth function is executable being found through the search. If the mobility enters the third section 233, the processor can change master permission from the third account to the fourth account. For example, if the mobility enters the third section 233, the processor can assign master permission to the fourth account, thus executing the fourth function, in the third section 233.

In some implementations, the processor can identify that the execution of the second function is required, in the fourth section 234. For example, the second function can be associated with a function for obtaining precise traffic information. By way of further example, the second function can be associated with a function for receiving high-definition (HD) map information from the outside.

In some implementations, the processor can search for a user account in which the second function is executable, based on that identifying that the execution of the second function is required, in the fourth section 234. Referring to FIG. 2B, the processor can search for a second account in which the second function is executable.

In some implementations, the processor can change the logged-in account from the fourth account to the second account, if the mobility enters the fourth section 234, based on the second account in which the second function is executable being found through the search. If the mobility enters the fourth section 234, the processor can change master permission from the fourth account to the second account. For example, if the mobility enters the fourth section 234, the processor can assign master permission to the second account, thus executing the second function, in the fourth section 234.

The accounts (e.g., the first account 210, the second account 220, the third account 230, and/or the fourth account 240) are described in FIGS. 2A to 2C, but the accounts described in FIGS. 2A to 2C can include a user account and/or account information described in FIG. 1.

As described above, the mobility control apparatus can identify a user account for executing a different function in each section. The mobility control apparatus can execute the required function, using the user account, thus reinforcing a user experience.

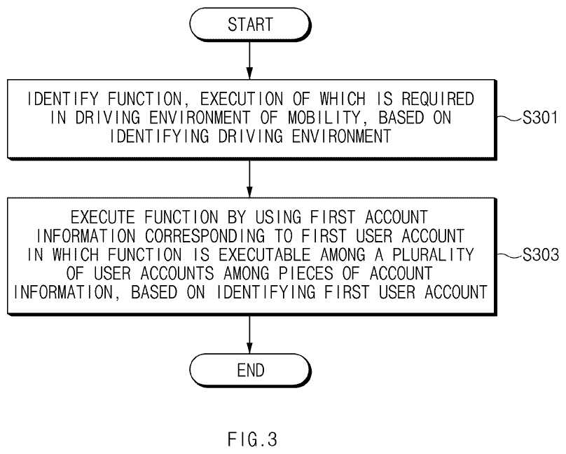

FIG. 3 is a diagram illustrating a flowchart describing an example of a mobility control method.

Hereinafter, it is assumed that a mobility control apparatus 100 of FIG. 1 performs a process of FIG. 3. Furthermore, in a description of FIG. 3, an operation described as being performed by an apparatus may be understood as being controlled by a processor 110 of the mobility control apparatus 100.

At least one of the operations of FIG. 3 can be performed by the mobility control apparatus 100 of FIG. 1. At least one of the operations of FIG. 3 can be controlled by the processor 110 of FIG. 1. The respective operations of FIG. 3 can be sequentially performed, but are not necessarily sequentially performed. For example, an order of the respective operations may be changed, and at least two operations may be performed in parallel.

Referring to FIG. 3, in S301, the mobility control method can include identifying a function that needs to be executed in a driving environment of a mobility, based on the driving environment being identified.

For example, the driving environment can include at least one of a section, an area, or a time, which is associated with driving of the mobility.

In some implementations, the function can include at least one of a driving assistance function of the mobility, an autonomous driving function of the mobility, a function for providing a user of the mobility with media content, a function associated with charging of the mobility, or a function for receiving traffic information for indicating a position of the mobility.

The mobility control method can include determining a requirement according to the driving environment. For example, the mobility control method can include identifying the function that needs to be executed in the driving environment, based on the requirement being determined according to the driving environment.

For example, the requirement according to the driving environment can include an item which needs to be provided to the user while the mobility is in motion in a corresponding section or is required in the mobility itself.

In some implementations, the mobility control method can include identifying the requirement, using at least one of at least one sensor included in the mobility, first map information stored in the mobility, or second map information received from a device different from the mobility.

For example, the at least one sensor can generate electronic information capable of being processed by a processor and/or a memory of the mobility control apparatus, from non-electronic information associated with the mobility control apparatus.

In some implementations, the at least one sensor can include image sensors such as high dynamic range cameras. For example, the at least one sensor can include non-visual sensors. By way of further example, the at least one sensor can include at least one of radio detection and ranging (RADAR), light detection and ranging (LiDAR), or an ultrasonic sensor, or any combination thereof, other than the image sensors.

In S303, the mobility control method can include executing the function by using first account information corresponding to a first user account in which the function is executable among a plurality of user accounts among pieces of account information, based on the first user account being identified.

For example, account information corresponding to each of the plurality of user accounts can be stored in the memory.

In some implementations, the mobility control method can include segmenting a driving section of the mobility into sub-sections, based on the driving section being identified, before the driving of the mobility is initiated.

In some implementations, the mobility control method can include identifying each of pieces of account information in which each of functions, which is required in each of the sub-sections, is executable, if the mobility enters each of the sub-sections, based on each of the functions being identified. For example, the mobility control method can include executing each of the functions in each of the sub-sections by using each of the pieces of account information in which each of the functions, which is required in each of the sub-sections, is executable, if the mobility enters each of the sub-sections, based on each of the functions being identified.

In some implementations, the mobility control method can include identifying a driving section to be driven from a starting point at which the driving of the mobility will be initiated to a destination at which the mobility will drive to arrive, based on the destination being identified.

The mobility control method can include identifying a user input requesting account switching, while the mobility is in motion. For example, the mobility control method can include identifying second account information corresponding to the user input requesting the account switching, based on the user input, while the mobility is in motion.

For example, the mobility control method can include switching a logged-in account to a second user account corresponding to the user input, based on the second account information corresponding to the user input being identified.

In some implementations, the mobility control method can assign master account permission to the first user account corresponding to the first account information. For example, the mobility control method can include executing the function by using a user account to which the master account permission is assigned and/or account information to which the master account permission is assigned.

In some implementations, the mobility control method can include executing the function, using the first user account to which the master account permission is assigned.

In some implementations, the mobility control method can include executing the function, based on logging in to an application for executing the function using the first account information.

As described above, the mobility control method can include using a different user account to execute a different function depending on the driving of the mobility.

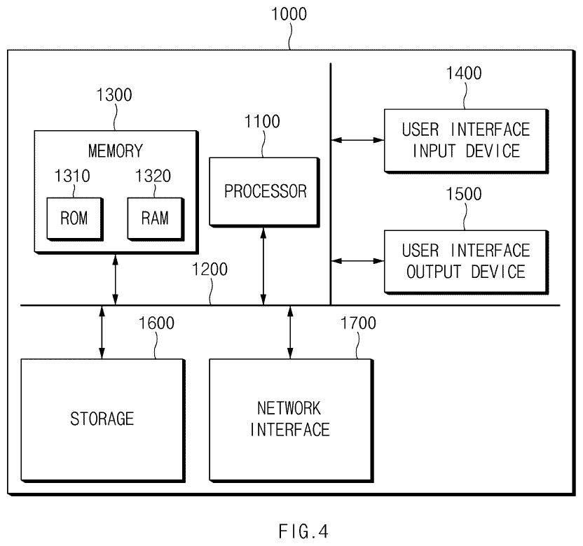

FIG. 4 is a diagram illustrating an example of a computing system associated with a mobility control apparatus or a mobility control method.

Referring to FIG. 4, a computing system 1000 can include at least one processor 1100, a memory 1300, a user interface input device 1400, a user interface output device 1500, storage 1600, and a network interface 1700, which are connected with each other via a bus 1200.

The processor 1100 can be a central processing unit (CPU) or a semiconductor device that processes instructions stored in the memory 1300 and/or the storage 1600. The memory and the storage 1600 can include various types of volatile or non-volatile storage media. For example, the memory 1300 can include a read only memory (ROM) 1310 and a random access memory (RAM) 1320.

Accordingly, the operations of the method or algorithm described in connection with the implementations disclosed in the specification may be directly implemented with a hardware module, a software module, or a combination of the hardware module and the software module, which is executed by the processor 1100. The software module can reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium can be coupled to the processor 1100. The processor 1100 can read out information from the storage medium and may write information in the storage medium. Alternatively, the storage medium can be integrated with the processor 1100. The processor and the storage medium may reside in an application specific integrated circuit (ASIC). The ASIC can reside within a user terminal. In another case, the processor and the storage medium can reside in the user terminal as separate components.

The present technology can change a master account depending on a driving environment of a mobility, if there are several accounts in a single mobility control apparatus.

Furthermore, the present technology can automatically change the master account depending on the selection of the user.

Furthermore, the present technology can operate the master account depending to the driving environment of the mobility, thus reinforcing personalization, reinforcing the usability of a feature on demand (FOD) service, and reinforcing a brand through efficient account operation.

What is claimed is:

1. A mobility control apparatus, comprising:
a memory configured to store instructions and a plurality of account information, each corresponding to a respective user account of a plurality of user accounts; and
a processor configured to execute the instructions to perform operations comprising:
identifying, based on a driving environment of a mobility, a function to be executed in the driving environment; and
executing the function by using first account information based on a first user account being identified among the plurality of user accounts, the first account information corresponding to the first user account in which the function is executable,
wherein the driving environment includes at least one of a section associated with an operation of the mobility, an area associated with the operation of the mobility, or a time associated with the operation of the mobility.

2. The mobility control apparatus of claim 1, wherein the operations comprise:
segmenting an identified driving section of the mobility into a plurality of sub-sections, before the mobility is in motion; and
executing, based on the mobility entering each of the plurality of sub-sections, a function corresponding to the sub-section to which the mobility enters by using a corresponding account information in which the function is executable.

3. The mobility control apparatus of claim 2, wherein the operations comprise:
based on a destination being identified, identifying the driving section to be travelled by the mobility from a starting point at which the operation of the mobility will be initiated to the destination.

4. The mobility control apparatus of claim 1, wherein the operations comprise:
identifying, based on user input requesting account switching being received, second account information corresponding to the user input, while the mobility is in motion, and
switching to a second user account corresponding to the user input, based on identifying the second account information.

5. The mobility control apparatus of claim 1, wherein the function includes at least one of a driving assistance function of the mobility, an autonomous driving function of the mobility, a function for providing a user of the mobility with media content, a function associated with charging of the mobility, or a function for receiving traffic information for indicating a position of the mobility.

6. The mobility control apparatus of claim 1, wherein the operations comprise:
identifying, based on a requirement being determined according to the driving environment, the function to be executed in the driving environment.

7. The mobility control apparatus of claim 6, wherein the operations comprise:
identifying the requirement based on at least one of at least one sensor included in the mobility, first map information stored in the mobility, or second map information received from a device different from the mobility.

8. The mobility control apparatus of claim 1, wherein the operations comprise:
assigning master account permission to the first user account corresponding to the first account information.

9. The mobility control apparatus of claim 8, wherein the operations comprise:
executing the function based on the first user account to which the master account permission is assigned.

10. The mobility control apparatus of claim 1, wherein the operations comprise:
executing the function based on logging into an application using the first account information.

11. A mobility control method, comprising:
identifying, by a processor, a function to be executed in a driving environment of a mobility, based on the driving environment; and
executing, by the processor, the function by using first account information based on a first user account being identified among a plurality of user accounts, the first account information corresponding to the first user account in which the function is executable,
wherein the driving environment includes at least one of a section associated with an operation of the mobility, an area associated with the operation of the mobility, or a time associated with the operation of the mobility.

12. The mobility control method of claim 11, further comprising:
segmenting an identified driving section of the mobility into a plurality of sub-sections, before the mobility is in motion; and
executing, based on the mobility entering each of the plurality of sub-sections, a function corresponding to the sub-section to which the mobility enters by using a corresponding account information in which the function is executable.

13. The mobility control method of claim 12, further comprising:
based on a destination being identified, identifying the driving section to be travelled by the mobility from a starting point at which the operation of the mobility will be initiated to the destination.

14. The mobility control method of claim 11, further comprising:
identifying, based on user input requesting account switching being received, second account information corresponding to the user input, while the mobility is in motion; and
switching to a second user account corresponding to the user input, based on identifying the second account information.

15. The mobility control method of claim 11, wherein the function includes at least one of a driving assistance function of the mobility, an autonomous driving function of the mobility, a function for providing a user of the mobility with media content, a function associated with charging of the mobility, or a function for receiving traffic information for indicating a position of the mobility.

16. The mobility control method of claim 11, further comprising:
identifying, based on a requirement being determined according to the driving environment, the function to be executed in the driving environment.

17. The mobility control method of claim 16, further comprising:
identifying the requirement based on at least one of at least one sensor included in the mobility, first map information stored in the mobility, or second map information received from a device different from the mobility.

18. The mobility control method of claim 11, further comprising:
assigning master account permission to the first user account corresponding to the first account information.

19. The mobility control method of claim 18, further comprising:
executing the function based on the first user account to which the master account permission is assigned.

20. The mobility control method of claim 11, further comprising:
executing the function based on logging into an application using the first account information.
